(19) United States
(12) Patent Application Publication
(10) Pub. No.: US 2026/0127618 A1
(43) Pub. Date: May 7, 2026

(54) TECHNOLOGIES FOR IN-STORE ONLINE ORDER FULFILLMENT FOR RETAIL STORES

(71) Applicant: Target Brands, Inc., Minneapolis, MN (US)

(72) Inventors: Neal DePape, Minnetonka, MN (US); Richard Noe, Custer, SD (US); Joshua Kelner, Minneapolis, MN (US); Bob Danielson, Plymouth, MN (US); Steve Martin Schwartz, New Richmond, WI (US); Jon Lamirault, Los Angeles, CA (US)

(21) Appl. No.: 18/934,791

(22) Filed: Nov. 1, 2024

(51) Int. Cl. G06Q 30/015; G06Q 10/0875; G06Q 20/20; G06Q 30/0601

(52) U.S. Cl. CPC G06Q 30/015; G06Q 10/0875; G06Q 20/208; G06Q 30/0633; G06Q 30/0603

(57) ABSTRACT

In some implementations, a method performed by data processing apparatuses includes determining whether a location of a customer device is within a predetermined proximity of the retail store. In response to determining that the location of the customer device is within the predetermined proximity, the method further includes receiving an item identifier from the customer device, determining a stock room location of the item in response to receiving the item identifier, sending a first notification indicative of the item, the stock room location, and a collection point to an employee device. The method further includes receiving a checkout request from the customer device, determining a pickup location within the retail store in response to receiving the checkout request, and sending a second notification to an employee device indicative of the collection point location and the pickup location. The stock room is a secured physical space of the retail store.

### TECHNICAL FIELD

This specification generally relates to techniques for order fulfillment for retail stores, particularly techniques for real-time fulfillment of in-store online orders.

### BACKGROUND

Organized retail theft is an increasing problem for retail stores. To respond to increased theft losses, many retail stores are moving certain, frequently-stolen items to locking cabinets or other locations that are not accessible to customers. In those stores, employees may be required to unlock cabinets or otherwise provide the items to each customer, which may reduce efficiency, increase costs, and detracts from the customer shopping experience. Besides retail theft considerations, traditional retail stores may have limited space for displaying bulky items such as cribs, strollers, or televisions.

Retail stores are increasingly using automated systems for retail store logistics management and order fulfillment. For example, many retail stores support online drive-up ordering of items, in which an employee gathers items for the customer and then provides the items to the customer, typically at the customer's vehicle, outside of the retail store. Such drive-up ordering may be performed by the customer using a mobile application, a website, or other digital fulfillment system provided by the retail store.

### SUMMARY

This document generally describes physical store arrangements, computer systems, processes, program products, and devices for fulfilling in-store orders in real-time and in combination with physical retail shopping. The technology described in this document involves a physical store arrangement including a sales floor/showroom having a limited selection of items available for customer selection, along with an expanded backroom picking area, and a checkout area. The customer may select items with a mobile application to be added to a virtual cart while also adding selected physical items to a physical shopping cart. An employee concurrently picks the items for the virtual cart from a secured backroom prior to the customer checking out. When the customer is finished shopping and checks out, the customer may pick up the items for the virtual cart from an identified pickup location such as a particular register or self-checkout location. Items from the customer's physical cart may be combined with the items from the virtual cart into a single checkout transaction, including a single payment transaction.

In some implementations, a method performed by data processing apparatuses includes determining, by a retail store system, whether a location of a customer device is within a predetermined proximity of the retail store; and in response to determining that the location of the customer device is within the predetermined proximity of the retail store: receiving, by the retail store system, an item identifier from the customer device; determining, by the retail store system, a stock room location of the item within the stock room of the retail store in response to receiving the item identifier, wherein the stock room is a secured physical space of the retail store; sending, by the retail store system, a first notification to an employee device, the first notification indicative of the item, the stock room location, and a collection point location; receiving, by the retail store system, a checkout request from the customer device; determining, by the retail store system, a pickup location within the retail store in response to receiving the checkout request, wherein the pickup location is a customer-accessible physical space of the retail store having a visible identifier; and sending, by the retail store system, a second notification to an employee device indicative of the collection point location and the pickup location.

Other implementations of this aspect include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. The method may further include scanning, by the customer device, an item identifier within a showroom of the retail store, wherein the showroom is a customer-accessible physical space of the retail store; and sending, by the customer device, the item identifier to the retail store system. Scanning the item identifier may further include scanning an item packaging unit indicative of the item identifier and located within the showroom of the retail store. The method may further include receiving, by the customer device, a selection of the item from the customer using a mobile application catalog; and sending, by the customer device, the item identifier to the retail store system in response to receiving the selection of the item. The method may further include identifying, by the retail store system, the employee device for picking the item from a plurality of employee devices in response to receiving the item identifier. identifying the employee device may include selecting the employee device from a plurality of employee devices based on proximity of the stock room location to a respective location of each of the plurality of employee devices; or selecting the employee device from a plurality of employee devices based on an item category associated with the item. Identifying the employee device may include prioritizing the item higher than a drive-up order or a delivery order. The method may further include determining, by the retail store system, the collection point location within the stock room of the retail store in response to receiving the item identifier. Determining the collection point location may include determining the collection point location based on the virtual cart associated with the customer; determining the collection point location based on a category associated with the item; or determining the collection point location based on the stock room location. Receiving the checkout request may include receiving the visible identifier of the pickup location from the customer device. Receiving the checkout request may include receiving a second location of the customer device, wherein the second location is within a predetermined proximity to the pickup location. The method may further include sending, by the retail store system, a third notification to the customer device indicative of the visible identifier of the pickup location. The method may further include determining, by the retail system, the pickup location, wherein sending the third notification comprises sending the third notification in response to determining the pickup location. The third notification may be further indicative of an estimated pickup time. The method may further include scanning, by a point of sale device, a physical item in the pickup location in the retail store; receiving, by the point of sale device, the list of requested items of the virtual cart from the retail store system; and processing, by the point of sale device, a payment transaction associated with the physical item and the list of requested items of the virtual cart.

In some implementations, a physical store arrangement includes wireless network coverage; a showroom comprising a customer-accessible physical space of a retail store containing (i) a first plurality of items available for customer self-service, and (ii) a first plurality of item identifiers accessible for scanning; stock room comprising a secured physical space of the retail store containing a second plurality of items, wherein the second plurality of items comprises items associated with the first plurality of item identifiers; and a pickup area comprising a customer-accessible physical space of the retail store having a visual identifier.

These and other implementations can include any, all, or none of the following features. The first plurality of item identifiers may include item packaging associated with second plurality of items.

The systems, devices, program products, and processes described throughout this document can, in some instances, provide one or more of the following advantages. In particular, the techniques described herein may reduce losses from retail theft while providing a desirable customer experience to customers of the retail store. Additionally, the techniques described herein may reduce the quantity of items and the space required for those items in the retail showroom, particularly for large or bulky items. Additionally, the techniques described herein may reduce costs, reduce potential fraud, and improve security by combining virtual cart transactions with physical cart transactions into a combined transaction, which may be a card present transaction at a point of sale system.

Other features, aspects and potential advantages will be apparent from the accompanying description and figures.

### DESCRIPTION OF DRAWINGS

FIG. 1 depicts an example system for order fulfillment for a retail store.

FIG. 2 is a flow diagram of an example technique for performing real-time in-store online ordering that may be executed by a customer device.

FIG. 3 is a flow diagram of an example technique for processing real-time in-store online ordering that may be executed by a retail store system.

FIG. 4 is a flow diagram of an example technique for fulfilling real-time in-store online ordering that may be executed by an employee device.

FIG. 5 is a flow diagram of an example technique for processing combined virtual cart and physical cart transactions that may be executed by a point of sale system.

FIG. 6 is a schematic diagram of illustrative physical store arrangement that may be used with the system and methods of FIGS. 1-5.

FIG. 7 is a schematic diagram that shows an example of a computing system.

Like reference symbols in the various drawings indicate like elements.

### DETAILED DESCRIPTION

This document describes technology for order fulfillment for a retail store. Briefly, the retail store includes a customer-accessible showroom and a secured back room. A customer in the store uses a customer device to scan an item in the showroom and send a request to a retail store system to add the item to a virtual cart. The retail store system may verify that the customer device is located at the retail store, and if not, may allow the customer to purchase the item as part of the transaction with shipping to the customer's home. If the item is located at the retail store, the retail store system sends a notification to an employee device identifying the item in the secured back room, and an employee retrieves the item. The retrieved item may be stored in a collection point in the stock room while the customer continues shopping. When the customer checks out, the retail store system sends another notification to an employee device identifying the virtual cart items (e.g., stored at the collection point) and a pickup location within the store. An employee retrieves the virtual cart items and delivers them to the pickup location. The virtual cart items may be purchased in a single purchase transaction along with any physical items that were selected by the customer from the showroom.

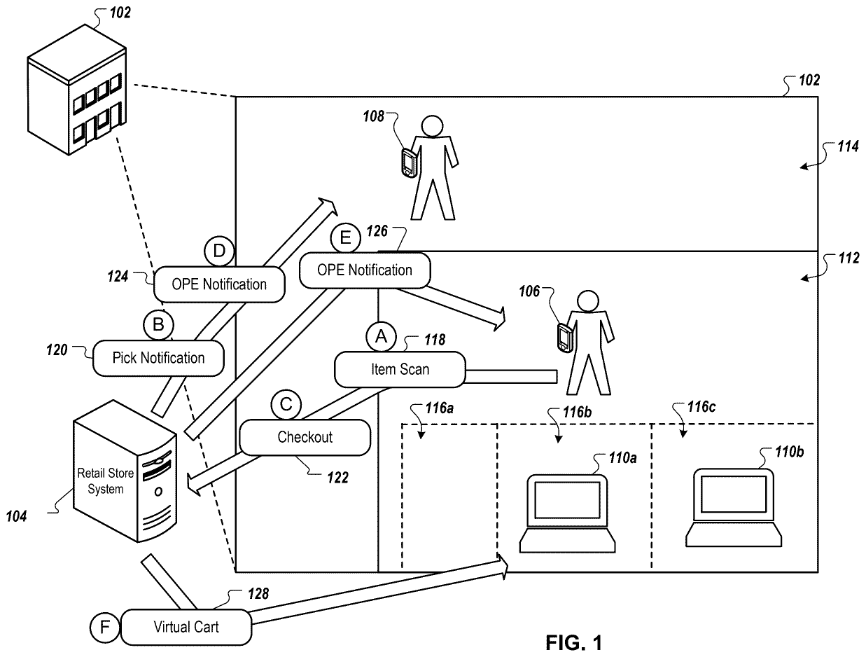

FIG. 1 depicts an example system 100 for processing real-time in-store orders at a retail store 102, as represented in example stages (A) to (F). Stages (A) to (F) may occur in the illustrated sequence, or they may occur in a sequence that is different than in the illustrated sequence, and/or two or more stages (A) to (F) may be concurrent. In some examples, one or more stages (A) to (F) may be repeated multiple times when retraining and/or servicing multiple API requests.

The system 100 can include a retail store system 104, one or more customer devices 106, one or more employee devices 108, and one or more point of sale device 110. The retail store system 104, for example, can include one or more computing servers and one or more data sources. In some examples, multiple of the system 104 can be combined into a single system, and/or any of the systems can be partitioned into two or more separate systems. In some examples, the computing servers can include various forms of servers, including but not limited to network servers, web servers, application servers, or other suitable computing servers. In some examples, the data sources can include databases, file systems, and/or cached data sources. The computing servers, for example, can access data from the data sources, can execute software that processes the accessed data, and can provide information based on the accessed/processed data to client devices that can be operated by users. Communication between the computing servers, the data sources, and the client devices, for example, can occur over one or more communication networks, including a LAN (local area network), a WAN (wide area network), a MAN (metro area network), and/or the Internet.

In the present example, a user such as a customer, a guest, or other user can employ a customer device 106 to access the retail store system 104. Similarly, a user such as an employee, a team member, or other user may employee an employee device 108 to access the retail store system 104. Each of the customer device 106 and the employee device 108 may be embodied as any mobile processing device including, but not limited to a smartphone, a laptop computer, a tablet computer, a personal digital assistant (PDA), or another processing device. As described further below, the customer devices 106 and the employee devices 108 may access the retail store system 104 while physically present at the retail store 102.

The retail store system 104 further includes one or more point-of-sale systems 110, which may be embodied as any computing device capable of performing the operations described herein, including but not limited to a cash register, a self-checkout kiosk, a desktop computer, a laptop computer, a tablet computer, a personal digital assistant (PDA), a smartphone, or another processing device.

As shown, the retail store system 104 is associated with a retail store 102, which in some embodiments may include a local positioning system. The local positioning system may be embodied as any device or collection of devices that allows customer devices 106 and/or employee devices 108 to determine their current physical location within a particular facility or other location. For example, the local positioning system may include a system of beacons installed in an indoor location (e.g., personal area network beacons or other radio beacons, visible light beacons installed in light fixtures and/or other location beacons).

The retail store 102 includes a physical store arrangement represented schematically in FIG. 1. In particular, the retail store 102 includes a showroom or sales floor 112, which may be embodied as a customer-accessible area of the store where certain items are available for self-service. The showroom 112 may include shelves, racks, and other fixtures for storing and displaying items as well as other equipment and fixtures typically found in a retail store. The retail store 102 also includes a stock room or back room 114, which may be embodied as a secured area of the store, not accessible to customers, in which items are stored. Similar to the showroom 112, the stock room 114 may also include shelves, racks, and other fixtures for storing items. In some embodiments, the stock room 114 may also include equipment such as flow racks and sortation centers in order to improve item picking efficiency. As described further below, compared to traditional retail stores, in the illustrative retail store 102, the back room 114 may be relatively larger and the showroom 112 may be relatively smaller. Accordingly, the showroom 112 may include a relatively smaller number of items compared to traditional retail stores. For example, in some embodiments, the showroom 112 may include a limited selection of items available for customer self-service (e.g., fresh produce). As another example, a reduced number of each type or category of item may be available in the showroom 112, with additional items in the stock room 114. In some embodiments, the showroom 112 may include packaging for items rather than the items themselves. Additionally or alternatively, although illustrated as including a showroom 112, in some embodiments the retail store 102 may be a traditional retail store 102, for example including a sales floor with a full selection of items for customer self-service.

The retail store 102 further includes one or more pickup areas 116. The illustrative retail store 102 shown in FIG. 1 includes three pickup areas 116a, 116b, 116c; however, other numbers of pickup areas 116 are possible in other embodiments. As shown, each pickup area may include or otherwise be collocated with a point of sale device 110 (e.g., illustrative point of sale devices 110a, 110b located at pickup areas 116b, 116c, respectively). Each pickup area 116 may also include a visible label, number, color code, symbol, visible identifier, or other identifier that allows a customer to identify a particular pickup area 116. For example, in an embodiment each pickup area 116 may simply include a numbered sign. As another example, in an embodiment, each pickup area 116 may include a beacon or other location system identifiable by the customer devices 106. Another illustrative embodiment of a physical store arrangement for the retail store 102 is described further below in connection with FIG. 6.

In use, a customer with a customer device 106 may interact with the system 100 while shopping, as represented in example stages (A) to (F). During stage (A), the customer device 106 sends an item scan 118 to the retail store system 104. The item scan 118 may be embodied as a bar code or other identifier associated with a particular item that the customer wishes to purchase. The item scan 118 may be captured, for example, when the customer scans the label of an item or item packaging within the showroom 112.

During stage (B), the retail store system 104 locates the requested item in stock in the stock room 114 and sends a pick notification 120 to a particular employee device 108. As described further below, the retail store system 104 may select a particular employee (i.e., an employee with appropriate training and/or otherwise associated with the particular employee device 108) in order to prioritize picking for real-time in-store orders. Upon receiving the notification 120, an employee associated with the employee device 108 retrieves the requested item from the stock room 114 and may position the requested item at a collection point within the stock room 114. At this point, the requested item may be considered to be within a “virtual cart” associated with the customer. When in the “virtual cart,” the item may be represented in a real-time online ordering virtual cart maintained by the retail store system 104 and accessible to the customer device 106, for example through a mobile application. Additionally, when in the “virtual cart,” the requested physical item may be located at a particular collection point in the stock room 114, for example along with other physical items included in the same virtual cart.

During stage (C), when the customer is finished shopping, the customer device 106 sends a checkout request 122 to the retail store system 104. This checkout request 122 may identify a particular pickup area 116, for example with an identifier input by the customer, or as another example based on the current location of the customer device 106. In some embodiments, the retail store system 104 may select a pickup area 116.

During stage (D), the retail store system 104 sends an order pickup at exit (OPE) notification 124 to an employee device 108. The OPE notification 124 may identify the particular collection location within the stock room 114 associated with the requested items included in the virtual cart of the customer. The OPE notification 124 may also identify a particular pickup area 116. Similarly, during stage (E), the retail store system 104 sends an OPE notification 126 to the customer device 106. The OPE notification 126 may also identify the pickup area 116, and may also include additional information relating to the virtual cart, such as pickup status. After the OPE notifications 124, 126 are received, an employee retrieves the physical items included in the virtual cart from the stock room 114 and provides them to the customer at the identified pickup area 116.

During stage (F), the virtual cart associated with the customer may be transferred to a point of sale device 110 located at the pickup area 116 for the virtual cart. The customer may complete an order transaction using the point of sale device 110. For example, the customer may submit cash, a payment card, or otherwise complete a payment transaction for the items in the virtual cart. In some embodiments, the requested items of the virtual cart may be combined with other physical items selected by the customer from within the self-service showroom 112 into a single transaction. After completing the transaction, the customer may exit the retail store with the purchased items from the virtual cart, along with any other purchased self-serve items.

Accordingly, the system 100 is capable of fulfilling retail orders in real time while the customer shops in the retail store. The customer is able to purchase items from the secured back room 114 without waiting for an employee to open locked cabinets or otherwise incurring delay, which improves efficiency for both the customer and the employee and prevents frustration for the customer. Additionally, and particularly for large or bulky items, the system 100 may provide an improved customer experience over traditional stores by allowing the customer to purchase items from the secured back room 114 without having to carry large items to the checkout or to wait for assistance from an employee. Additionally, the system 100 may allow for self-service shopping for important categories of items such as fresh produce, which preserves a welcoming, enjoyable retail shopping experience for customers. By allowing physical self-service items to be purchased with virtual cart items in a single transaction, the system 100 may improve convenience for customers, and may also reduce the costs associated with fraudulent transactions.

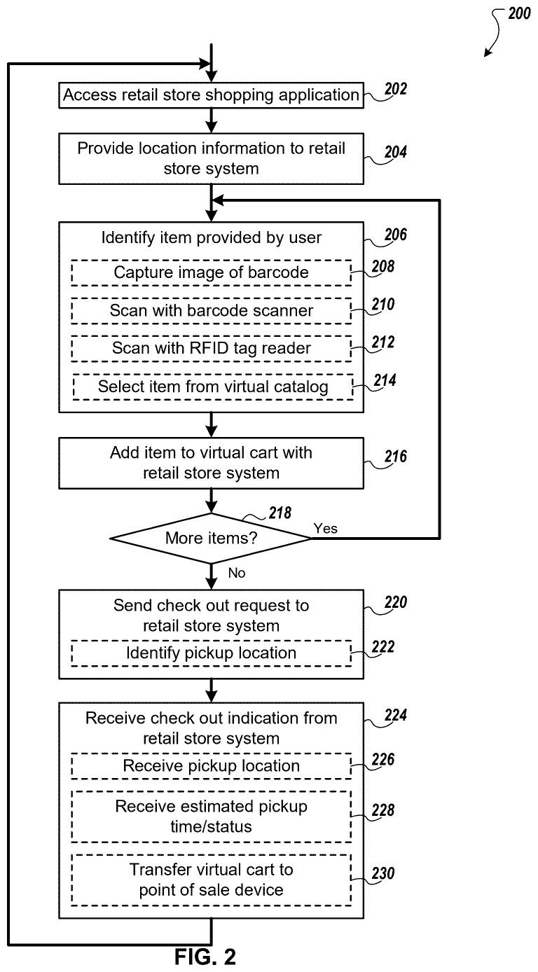

Referring now to FIG. 2, a flow diagram of an example method 200 is shown for real-time in-store online ordering. In the present example, the method 200 can be performed by components of the system 100 such as a customer device 106, and will be described with reference to FIG. 1. However, other systems may be used to perform the same or a similar process.

At 202, the customer device 106 accesses a retail store shopping application. The retail store shopping application may be embodied as a native application, a web application, or other application or collection of applications capable of accessing the retail stores system 104 as described further below.

At 204, the customer device 106 provides location information to the retail store system 104. The location information may include any information establishing that the customer device 106 is currently located near the retail store 102 (e.g., within a predetermined distance of the retail store 102 or otherwise in proximity to the retail store 102). For example, the location information may include coordinates or other geo-location of the customer device 106. As another example, the location information may be established by through one or more resources located at the retail store 102, such as a connection to a wireless network located at the retail store 102.

At 206, the customer device 106 scans or otherwise identifies an item provided by a user such as a customer. The scanned item may be embodied as a physical item and/or packaging for an item (with or without the actual item include in the packaging) located within the physical showroom 112 of the retail store 102. In some embodiments, at 208 the customer device 106 may capture an image of a barcode included on the item and/or the item packaging. The customer device 106 may, for example, capture the image of the barcode using a camera or other image capture device included in the customer device 106. In some embodiments, at 210, the customer device 106 may scan the item with a barcode scanner included in the customer device 106 or otherwise coupled to the customer device 106. In some embodiments, at 212, the customer device 106 may scan the item with a radio frequency identifier (RFID) tag reader, which may be included in the customer device 106 or otherwise coupled to the customer device 106.

In some embodiments, at 214 the customer device 106 may select the item from a virtual catalog. For example, in some embodiments the user may select one or more items from a virtual store catalog using the customer device 106, an interactive kiosk, or other device. In an embodiment, the virtual store catalog may be generated dynamically based on items currently available for real-time in-store ordering at the retail store 102. In some embodiments, the customer device 106, an interactive kiosk, or other device may provide a demonstration of a media item such as a video game, a movie, music, or other media. The user may select the media item (e.g., video game cartridge or disc, media disc, vinyl record, etc.) using the mobile application or kiosk.

At 216, the customer device 106 adds the scanned item to a virtual cart maintained by the retail store system 104. The customer device 106 may, for example, send a request to add the item to the virtual cart to the retail store system 104. This request may include a universal product code (UPC), numeric identifier, or other identifier of the requested item determined based on the scan of the item, based on the selection of the item, or other identification of the item. The customer device 106 may, for example, decode the scanned bar code or otherwise determine the identifier of the requested item. Additionally or alternatively, in some embodiments, the request may include a captured image or other scan data of the requested item. As discussed further below, after the requested item is added to the virtual cart, an employee will pick a physical item from the stock room 114 while the customer continues to shop in the showroom 112.

At 218, the customer device 106 determines whether additional items may be added to the virtual cart. For example, the customer device 106 may determine whether the user has selected to check out or otherwise end the current shopping session. If not, the method 200 loops back to block 206 to continue scanning items. If no additional items will be scanned, the method 200 advances to block 220.

At 220, the customer device 106 sends a checkout request to the retail store system 104. In some embodiments, at 222 the customer device 106 may identify a pickup location 116 within the retail store 102. For example, the customer device 106 may receive a user input describing a requested pickup location 116, such as a number, a label, or other visible identifier associated with the requested pickup location 116. Additionally or alternatively, the customer device 106 may identify a pickup location 116 by providing the current location of the customer device 106.

At 224, the customer device 106 receives a checkout indication from the retail store system 104. In some embodiments, at 226 the customer device 106 may receive the pickup location from the retail store system 104. The customer device 106 may, for example, display the number, the label, or other visual identifier associated with the pickup location 116 for reference of the user. In some embodiments, at 228 the customer device 106 may receive an estimated pickup time or other status update associated with the virtual cart. In some embodiments, at 230 the customer device 106 may transfer the virtual cart to a point of sale device 110. Transferring the virtual cart allows the point of sale device 110 to process a transaction for all items included in the virtual cart, along with other self-service items provided by the customer. The customer device 106 may use any technique to transfer the virtual cart. For example, the customer device 106 may transfer the virtual cart directly using a network request or other data transfer. As another example, the customer device 106 may display a barcode or other information indicative of the virtual cart which may be scanned by the point of sale device 110. Of course, in other embodiments one or more other devices of the system 100, such as the retail store system 104 and/or the employee device 108 may transfer the virtual cart to the point of sale device 110. After receiving the checkout indication, the method 200 may loop back to block 202, in which the customer device 106 may perform additional shopping tasks.

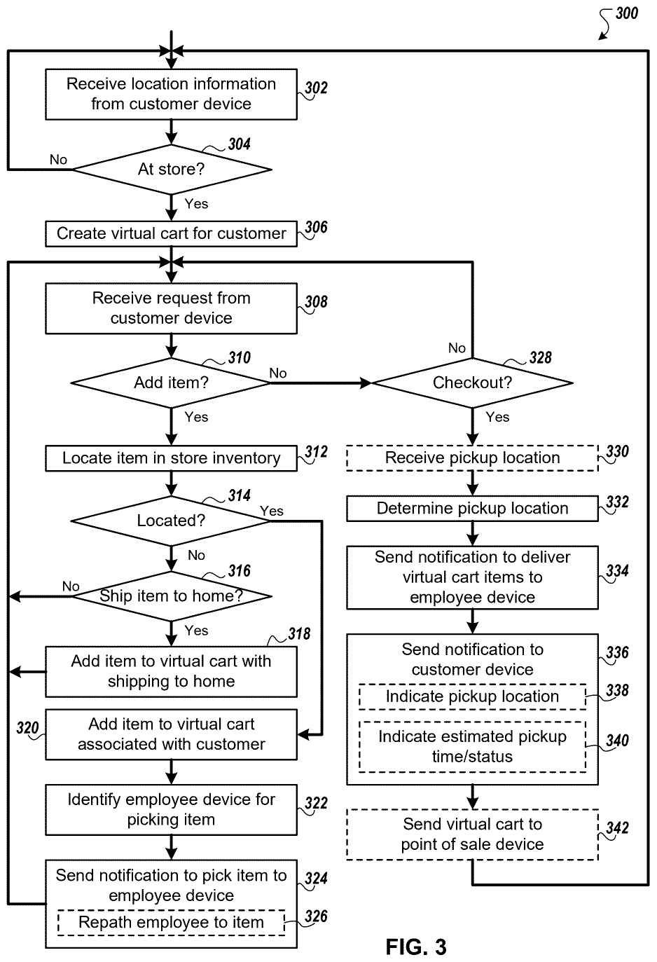

Referring now to FIG. 3, a flow diagram of an example method 300 is shown for processing real-time in-store ordering. In the present example, the method 300 can be performed by components of the system 100 such as the retail store system 104, and will be described with reference to FIG. 1. However, other systems may be used to perform the same or a similar process.

At 302, the retail store system 104 receives location information from a customer device 106. As described above, the location information may include any information establishing the current location of the customer device 106. At 304, the retail store system 104 determines whether the customer device 106 is currently located at the retail store 102 based on the location information. For example, the retail store system 104 may determine whether the customer device 106 is currently located within a predetermined distance of the retail store 102 or otherwise located in proximity to the retail store 102. As another example, the retail store system 104 may determine whether the customer device 106 has access to one or more resources located at the retail store 102, such as a wireless network located at the retail store 102. If the customer device 106 is not located at the retail store 102, then the method 300 loops back to block 302 to process additional requests. If the customer device 106 is located at the retail store 102, then the method 304 advances to 306, in which the retail store system 104 may create a virtual cart for the customer associated with the customer device 106. Accordingly, real-time ordering with a virtual cart (as opposed to online ordering or drive-up ordering) may only be available to customers currently located within or otherwise in proximity to a retail store 102.

At 308, the retail store system 104 receives a request from the customer device 106. The request may be submitted by the customer device 106 using a retail store application, such as a native application, a web application, or other application. Accordingly, the retail store system 104 may receive multiple types or classes of requests from the customer device 106. At 310, the retail store system 104 determines whether a request to add an item to the virtual cart has been received. If not, the method 300 branches to block 328, described further below. If a request to add an item has been received, the method 300 advances to block 312.

At 312, the retail store system 104 locates the requested item in store inventory. As described above, the request received from the customer device 106 may include a universal product code (UPC), numeric identifier, or other identifier of the requested item determined when the customer device 106 scanned the item and/or the item packaging. Additionally or alternatively, in some embodiments, the request may include a captured image or other scan data of the requested item. Based on the identifying information for the requested item, the retail store system 104 determines whether the item is available in inventory in the stock room 114 of the retail store 102. For example, the retail store system 102 may query a store inventory database or other database with an identifier associated with the requested item. The retail store system 104 may also determine a location for the item, for example a shelf and bin number or other location information.

At 314, the retail store system 104 determines whether the item was successfully found in inventory. If so, the method 300 advances to block 320, described below. If the item was not found in inventory, the method 300 advances to block 316, in which the retail store system 104 determines whether to ship the requested item to the customer's home. For example, the retail store system 104 may provide an informational message with one or more additional purchasing options (e.g., home delivery, same-day delivery from a nearby store via a delivery service, or other alternative fulfillment methods), or other response to the customer device 106, and may receive a subsequent response from the customer device 106. If the retail store system 104 determines not to ship the requested item, the method 300 loops back to block 308 to process additional requests from the client device 106. If the retail store system 104 determines to ship the requested item, the method 300 advances to block 318, in which the retail store system 104 adds the requested item to the virtual cart associated with the customer. As described further below, items in the virtual cart (including ship-to-home items) may be purchased together with physical cart items in a single sales transaction. After adding the requested item to the virtual cart with shipping to home, the method 300 loops back to block 308 to process additional requests from the client device 106.

Referring again to block 314, if the requested item was located in inventory, the method 300 advances to block 320. At 320, the retail store system 104 adds the requested item to the virtual cart associated with the customer. As described above, when an item is added to the virtual cart, the item may be represented in a real-time online ordering virtual cart maintained by the retail store system 104 and accessible to the customer device 106, for example through a mobile application. Additionally, and as described further below, when in the virtual cart, the requested physical item may be located at a particular collection point in the stock room 114, for example along with other physical items included in the same virtual cart. In some embodiments, the retail store system 104 may determine a collection point location for the virtual cart. For example, in an embodiment, items for each virtual cart may be located at the same collection point location, which may be identified or otherwise organized by customer name or other customer identifier.

Accordingly, at 322 the retail store system 104 identifies an employee device 108 for picking the requested item from its location in the stock room 114. The retail store system 104 may use any appropriate criteria for selecting the employee device 108. For example, in some embodiments the retail store system 104 may select an employee device 108 with a current location nearest to the item in the stock room 114 or otherwise select the employee device 108 based on proximity to the requested item. Additionally or alternatively, in some embodiments the retail store system 104 may select the employee device 108 based on an item category or department associated with the item. For example, certain employees may be trained for item picking, and/or certain employees may handle picking items for a particular assigned department (e.g., electronics, housewares, etc.).

At 324, the retail store system 104 sends a notification to the selected employee device 108 to pick the requested item. The notification may identify the item and/or the current location of the item in the stock room 114. The notification may also identify a collection point location for the picked item. The collection point location may be embodied as a location within the stock room 114 where picked items that are included in a virtual cart are temporarily stored while the customer is shopping in the retail store 102. As described above, items for each virtual cart may be located at a dedicated collection point location. Additionally or alternatively, the collection point location may be determined based on item category or department or another organization scheme.

In some embodiments, at 326 the retail store system 104 may repath an employee to the requested item. The retail store system 104 may, for example, add the requested item to a list of one or more items that an employee is currently picking. The retail store system 104 may update or otherwise modify routing or other directions to the employee to include the current location of the requested item. In some embodiments, the retail store system 104 may prioritize the requested item for real-time picking over items that are requested for traditional order pickup, drive-up orders, home delivery orders, or other orders. For example, the requested item may be given a shorter deadline for picking, such that the item is retrieved while the customer continues to shop in the retail store 102. As another example, the requested item may be inserted into the employee's picking list before other orders.

After receiving the notification with the employee device 108, the employee retrieves the requested item from its location in the stock room 114 and delivers it to the collection point location, which is also within the stock room 114. Additionally or alternatively, although illustrated as processing a request to add an item to the virtual cart, the retail store system 104 may also process requests to remove items from the virtual cart, for example when a customer no longer wishes to purchase an item. Requests to remove items from the virtual cart may be processed similarly to requests to add items to the virtual cart, for example by sending a notification to the employee device 108 identifying the collection point location of the item and the location in the stock room 114 to which to return the item. After sending the notification, the method 300 loops back to block 308 to continue processing requests from the customer device 106.

Referring again to block 310, if the request from the customer device 106 is not a request to add an item, the method 300 branches to block 328. At 328, the retail store system 104 determines whether the request is a request to check out or otherwise complete the shopping session. If not, the method 300 loops back to block 308 to continue processing requests from the customer device 106. If a request to checkout has been received, the method 300 advances to block 330.

In some embodiments, at 330 the retail store system 104 receives a pickup location from the customer device 106. As described above, the pickup location may be included in the checkout request or otherwise provided by the customer device 106. At 332, the retail store system 104 determines the pickup location 116 within the retail store 102. This pickup location may be based on the requested pickup location received from the customer device 102 or may be determined by the retail store system 104. As described above, the customer device 106 may send user input describing a requested pickup location 116, such as a number, a label, or other visible identifier associated with the requested pickup location 116. Additionally or alternatively, the customer device 106 may providing the current location of the customer device 106, which may be used by the retail store system 104 to select a pickup location 116, for example based on proximity. The retail store system 104 may use one or more other factors to determine the pickup location 116, such as employee availability, line length, or other factors.

At 334, the retail store system 104 sends a notification to an employee device 108 to deliver the items in the virtual cart to the pickup location 116. The retail store system 104 may use any appropriate criteria to select the employee device 108 to receive the notification, such as proximity, employee availability, item category or department, or other factors. Accordingly, the notification may be sent to the same employee device 108 that handled picking one or more of the items, or to another employee device 108. The notification may identify the collection point location (or collection point locations) at which the virtual cart items are located and the selected pickup location 116. The notification may also identify a particular virtual cart, for example by customer name or identifier. In some embodiments, the notification (or other functionality provided by the retail store system 104) may also provide a list of the items included in the virtual cart, which may allow an employee to verify that the correct physical items have been collected. The notification further identifies the selected pickup location 116, for example by including a number, a label, or other visible identifier associated with the requested pickup location 116. After receiving the notification, the employee may retrieve the items from the collection point location and deliver them to the identified pickup location 116.

At 336, the retail store system 104 sends a notification to the customer device 106. In some embodiments, at 338 the retail store system 104 may send the identified pickup location 116 to the customer device 106. As described above, the customer device 106 may, for example, display the number, the label, or other visual identifier associated with the pickup location 116 for reference of the user. In some embodiments, at 340 the retail store system 104 may send an estimated pickup time or other status update associated with the virtual cart. The status update may indicate, for example, when an employee has been notified to collect the virtual cart items. Additionally or alternatively, in some embodiments the estimated pickup time and/or the status update may be sent to the employee device 108, for example included in the notification described above in connection with block 334.

In some embodiments, at 342 the retail store system 104 may transfer the virtual cart to a point of sale device 110. The point of sale device 110 may be located at or otherwise associated with the selected pickup location 116. As described above, transferring the virtual cart allows the point of sale device 110 to process a transaction for all items included in the virtual cart, along with other self-service items provided by the customer. The retail store system 104 may use any technique to transfer the virtual cart. For example, the retail store system 104 may transfer the virtual cart using a network request or other data transfer. As another example, the retail store system 104 may generate a barcode or other information indicative of the virtual cart which may be scanned by the point of sale device 110. After notifying the employee device 108 and the customer device 106 and, in some embodiments, transferring the virtual cart to the point of sale device 110, the method 300 loops back to block 302, in which the retail store system 104 may process additional shopping sessions.

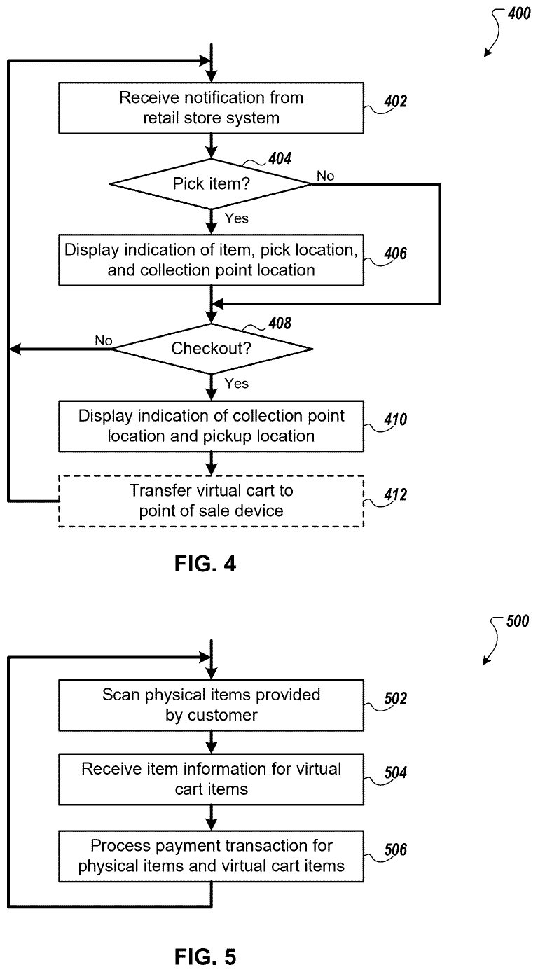

Referring now to FIG. 4, a flow diagram of an example method 400 is shown for fulfilling real-time in-store ordering. In the present example, the method 400 can be performed by components of the system 100 such as an employee device 108, and will be described with reference to FIG. 1. However, other systems may be used to perform the same or a similar process.

At 402, the employee device 108 receives a notification from the retail store system 104. The notification may be received, for example, by a mobile application, a web application, or other application executed by the employee device 108. Accordingly, the employee device 108 may receive multiple types or classes of notifications or other requests from the retail store system 104. At 404, the employee device 108 determines whether a request to pick an item has been received. If not, the method 400 branches to block 408, described below. If so, the method 400 advances to block 406.

At 406, the employee device 108 displays an indication of the requested item, the pick location, and the collection point location. The pick location may include a particular location within the stock room 114 at which the item is located, such as shelf and bin number or other location information. As discussed above, the collection point location may be embodied as a location within the stock room 114 where picked items that are included in a virtual cart are temporarily stored while the customer is shopping in the retail store 102. As described above, items for each virtual cart may be located at a dedicated collection point location. Accordingly, in some embodiments the employee device 108 may display an identifier of the customer virtual cart, such as customer name or other customer identifier. Additionally or alternatively, the collection point location may be determined based on item category or department or another organization scheme. After this information from the notification is displayed, the employee associated with the employee device 108 retrieves the item from the location in the stock room 114 and delivers it to the collection point location.

Referring again to block 404, if a request to pick an item was not received, the method 400 branches to block 408, at which the employee device 108 determines whether a checkout notification has been received. If not, the method 400 loops back to block 402 to continue processing notifications from the retail store system 104. If a checkout notification was received, the method 400 advances to block 410.

At 410, the employee device 108 displays an indication of the collection point location and the pickup location 116 received from the retail store system 104. As described above, the notification may identify the collection point location (or collection point locations) at which the virtual cart items are located and the selected pickup location 116. The notification may also identify a particular virtual cart, for example by customer name or identifier. In some embodiments, the notification (or other functionality provided by the retail store system 104) may also provide a list of the items included in the virtual cart, which may allow an employee to verify that the correct physical items have been collected. The notification further identifies the selected pickup location 116, for example by including a number, a label, or other visible identifier associated with the requested pickup location 116. After the information from the notification is displayed, the employee associated with the employee device 108 may retrieve the items from the collection point location and deliver them to the identified pickup location 116.

In some embodiments, at 412 the employee device 108 may transfer the virtual cart to a point of sale device 110. As described above, the point of sale device 110 may be located at or otherwise associated with the selected pickup location 116. Transferring the virtual cart allows the point of sale device 110 to process a transaction for all items included in the virtual cart, along with other self-service items provided by the customer. The employee device 108 may use any technique to transfer the virtual cart. For example, the employee device 108 may transfer the virtual cart directly using a network request or other data transfer. As another example, the employee device 108 may display a barcode or other information indicative of the virtual cart (e.g., received from the retail store system 104) which may be scanned by the point of sale device 110. After displaying the notification information received from the retail store system 104 and in some embodiments transferring the virtual cart to the point of sale device 110, the method 400 loops back to block 402, in which the employee device 108 may process additional notifications from the retail store system 104.

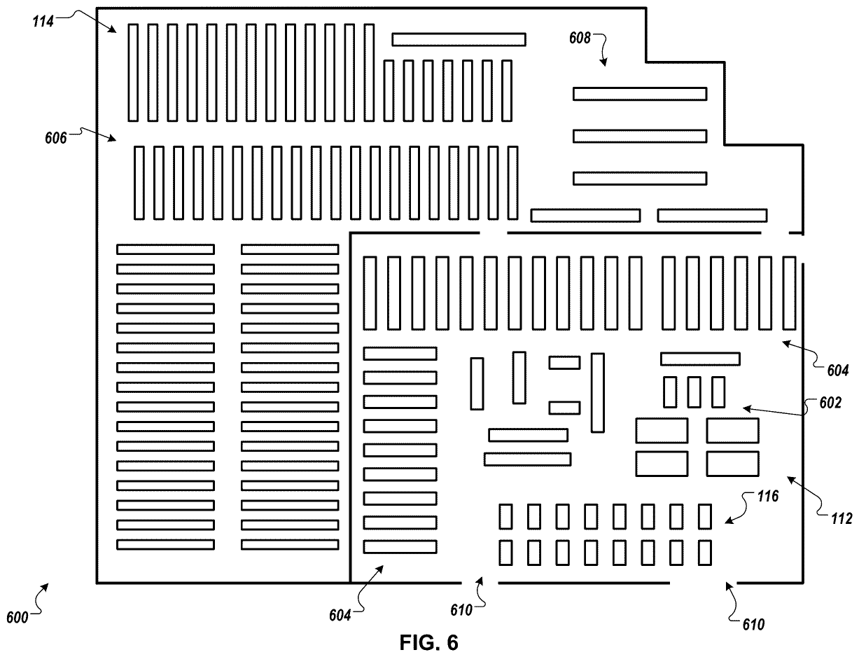

Referring now to FIG. 5, a flow diagram of an example method 500 is shown for processing combined virtual cart and physical cart transactions. In the present example, the method 500 can be performed by components of the system 100 such as a point of sale device 110, and will be described with reference to FIG. 1. However, other systems may be used to perform the same or a similar process.

At 502, the point of sale device 110 scans one or more physical items provided by the customer. The point of sale device 110 may, for example, scan a barcode included on each physical item or packaging of each physical item using a bar code scanner or other input device.

At 504, the point of sale device 110 receives item information for one or more virtual cart items. The point of sale device 110 may use any technique to receive item information for the virtual cart. For example, the point of sale device 110 may receive the virtual cart information using a network request or other data transfer from the retail store system 104, the customer device 106, and/or the employee device 108. As another example, the point of sale device 110 the retail store system 104 may scan a barcode or other information indicative of the virtual cart, which may be displayed by the customer device 106, the employee device 108, or another device. The point of sale device 110 may use this scanned identifier to request the virtual cart items from the retail store system 104, for example.

At 506, the point of sale device 110 processes a payment transaction for the scanned physical items together with the virtual cart items. The point of sale device 110 may, for example, process a payment card transaction, gift card transaction, cash transaction, or other transaction. In some embodiments, the transaction may be processed as a card present transaction, which may have reduced processing fees as compared to typical online orders or other remote transactions. After processing the payment transaction, the method 500 loops back to block 502, in which the point of sale device 110 may process additional orders.

Referring now to FIG. 6, a schematic diagram 600 illustrates one potential embodiment of a physical store arrangement for the retail store 102. As described above, the retail store 102 includes a showroom 112 and a stock room 114, as well as multiple pickup locations 116. The illustrative showroom 112 is a customer-accessible area of the store where certain items are available for self-service. As shown, the showroom 112 includes shelves 602 including items available for self-service such as fresh produce. Accordingly, the self-service shelves 602 may include coolers or other specialized fixtures adapted to the self-service items. As shown, the self-service shelves 602 may be close to one or more store entrances 610, which may provide a welcoming and enjoyable shopping experience for customers. The illustrative showroom 112 further includes additional shelving 604. The shelving 604 may include additional items for self-service, as well as sample items, item packaging, labels, or other items available to be added to the customer's virtual cart. Accordingly, customers may inspect item packaging and/or sample items in the shelves 604 prior to selecting the items for purchase, and customers are not required to find an employee to unlock locked cabinets or shelves in order to request adding the items to the virtual cart.

The illustrative stock room 114 includes shelving 606 for storing items. In the illustrative embodiment, the items stored in the stock room 114 may correspond to the items available for purchase in the shelves 604 of the showroom 112. Accordingly, other than the select items available for self-service in the shelves 602, the majority of items in inventor in the retail store 102 may be stored in the stock room 114, which is a secured area and not accessible to customers. Thus, as illustrated in FIG. 6, the stock room 114 is relatively larger than the showroom 112, and is also relatively larger than stock rooms used in traditional retail stores. Of course, as described above, in some embodiments the system 100 may be used with a traditional retail store having a stock room of typical size. The stock room 114 further includes collection point shelving 608, which may be used for staging or otherwise temporarily storing items that are added to virtual carts.

As shown, the showroom 112 further includes multiple pickup areas 116, which illustratively coincide with the cash register/point of sale locations of the retail store 102. In the illustrative embodiment, when a customer is done shopping and has entered a point of sale location, the customer device 106 may send a notification to the retail store system 104 identifying the current pickup location 116. The retail store system 104 may send a notification to an employee device 108 to retrieve the virtual cart items and deliver them to the identified pickup location 116. As the virtual cart items have been picked and staged at the collection point location during the customer's shopping trip, the virtual cart items may be quickly delivered to the pickup location 116.

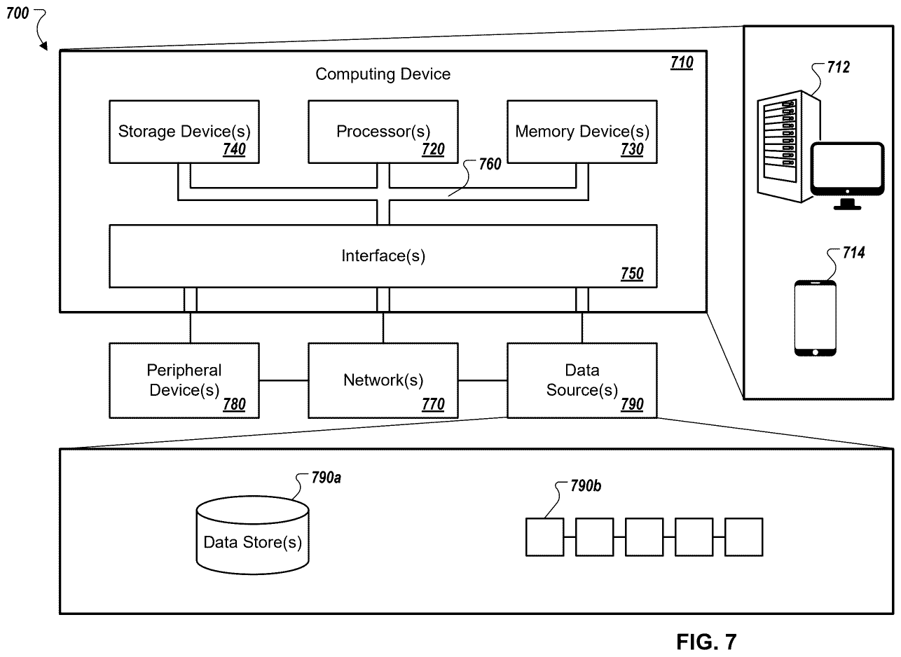

FIG. 7 is a schematic diagram that shows an example of a computing system 700 that can be used to implement the techniques described herein. The computing system 700 includes one or more computing devices (e.g., computing device 710), which can be in wired and/or wireless communication with various peripheral device(s) 780, data source(s) 790, and/or other computing devices (e.g., over network(s) 770). The computing device 710 can represent various forms of stationary computers 712 (e.g., workstations, kiosks, servers, mainframes, edge computing devices, quantum computers, etc.) and mobile computers 714 (e.g., laptops, tablets, mobile phones, personal digital assistants, wearable devices, etc.). In some implementations, the computing device 710 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 710, and an entire system can be made up of multiple devices communicating with each other. For example, the computing device 710 can be part of a computing system that includes a network of computing devices, such as a cloud-based computing system, a computing system in an internal network, or a computing system in another sort of shared network. Processors of the computing device (710) and other computing devices of a computing system can be optimized for different types of operations, secure computing tasks, etc. The components shown herein, and their functions, are meant to be examples, and are not meant to limit implementations of the technology described and/or claimed in this document.

The computing device 710 includes processor(s) 720, memory device(s) 730, storage device(s) 740, and interface(s) 750. Each of the processor(s) 720, the memory device(s) 730, the storage device(s) 740, and the interface(s) 750 are interconnected using a system bus 760. The processor(s) 720 are capable of processing instructions for execution within the computing device 710, and can include one or more single-threaded and/or multi-threaded processors. The processor(s) 720 are capable of processing instructions stored in the memory device(s) 730 and/or on the storage device(s) 740. The memory device(s) 730 can store data within the computing device 710, and can include one or more computer-readable media, volatile memory units, and/or non-volatile memory units. The storage device(s) 740 can provide mass storage for the computing device 710, can include various computer-readable media (e.g., a floppy disk device, a hard disk device, a tape device, an optical disk device, a flash memory or other similar solid state memory device, or an array of devices, including devices in a storage area network or other configurations), and can provide data security/encryption capabilities.

The interface(s) 750 can include various communications interfaces (e.g., USB, Near-Field Communication (NFC), Bluetooth, WiFi, Ethernet, wireless Ethernet, etc.) that can be coupled to the network(s) 770, peripheral device(s) 780, and/or data source(s) 790 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 750 can include a control interface that receives commands from an input device (e.g., operated by a user) and converts the commands for submission to the processors 720. The interface(s) 750 can include a display interface that includes circuitry for driving a display to present visual information to a user. The interface(s) 750 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 770 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 710 can communicate with the peripheral device(s) 780, the data source(s) 790, and/or other computing devices over the network(s) 770. In some implementations, the computing device 710 can directly communicate with the peripheral device(s) 780, the data source(s), and/or other computing devices.

The peripheral device(s) 780 can provide input/output operations for the computing device 710. Input devices (e.g., keyboards, pointing devices, touchscreens, microphones, cameras, scanners, sensors, etc.) can provide input to the computing device 710 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 710 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 790 can provide data for use by the computing device 710, and/or can maintain data that has been generated by the computing device 710 and/or other devices (e.g., data collected from sensor devices, data aggregated from various different data repositories, etc.). In some implementations, one or more data sources can be hosted by the computing device 710 (e.g., using the storage device(s) 740). In some implementations, one or more data sources can be hosted by a different computing device. Data can be provided by the data source(s) 790 in response to a request for data from the computing device 710 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 790a (e.g., databases, or other sorts of data management systems). The data store(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 790b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer-or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks.

Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer-implemented method for order fulfillment in a retail store, the method comprising:
determining, by a retail store system, whether a location of a customer device is within a predetermined proximity of the retail store; and
in response to determining that the location of the customer device is within the predetermined proximity of the retail store:
receiving, by the retail store system, an item identifier from the customer device;
determining, by the retail store system, a stock room location of the item within the stock room of the retail store in response to receiving the item identifier, wherein the stock room is a secured physical space of the retail store;
sending, by the retail store system, a first notification to an employee device, the first notification indicative of the item, the stock room location, and a collection point location;
receiving, by the retail store system, a checkout request from the customer device;
determining, by the retail store system, a pickup location within the retail store in response to receiving the checkout request, wherein the pickup location is a customer-accessible physical space of the retail store having a visible identifier; and
sending, by the retail store system, a second notification to an employee device indicative of the collection point location and the pickup location.

2. The method of claim 1, further comprising:
scanning, by the customer device, an item identifier within a showroom of the retail store, wherein the showroom is a customer-accessible physical space of the retail store; and
sending, by the customer device, the item identifier to the retail store system.

3. The method of claim 2, wherein scanning the item identifier further comprises scanning an item packaging unit indicative of the item identifier and located within the showroom of the retail store.

4. The method of claim 1, further comprising:
receiving, by the customer device, a selection of the item from the customer using a mobile application catalog; and
sending, by the customer device, the item identifier to the retail store system in response to receiving the selection of the item.

5. The method of claim 1, further comprising identifying, by the retail store system, the employee device for picking the item from a plurality of employee devices in response to receiving the item identifier.

6. The method of claim 5, wherein identifying the employee device comprises:
selecting the employee device from a plurality of employee devices based on proximity of the stock room location to a respective location of each of the plurality of employee devices; or
selecting the employee device from a plurality of employee devices based on an item category associated with the item.

7. The method of claim 1, wherein identifying the employee device comprises prioritizing the item higher than a drive-up order or a delivery order.

8. The method of claim 1, further comprising determining, by the retail store system, the collection point location within the stock room of the retail store in response to receiving the item identifier.

9. The method of claim 8, wherein determining the collection point location comprises:
determining the collection point location based on the virtual cart associated with the customer;
determining the collection point location based on a category associated with the item; or
determining the collection point location based on the stock room location.

10. The method of claim 1, wherein receiving the checkout request comprises receiving the visible identifier of the pickup location from the customer device.

11. The method of claim 1, wherein receiving the checkout request comprises receiving a second location of the customer device, wherein the second location is within a predetermined proximity to the pickup location.

12. The method of claim 1, further comprising sending, by the retail store system, a third notification to the customer device indicative of the visible identifier of the pickup location.

13. The method of claim 12, further comprising determining, by the retail system, the pickup location, wherein sending the third notification comprises sending the third notification in response to determining the pickup location.

14. The method of claim 12, wherein the third notification is further indicative of an estimated pickup time.

15. The method of claim 1, further comprising:
scanning, by a point of sale device, a physical item in the pickup location in the retail store;
receiving, by the point of sale device, the list of requested items of the virtual cart from the retail store system; and
processing, by the point of sale device, a payment transaction associated with the physical item and the list of requested items of the virtual cart.

16. A physical store arrangement comprising:
wireless network coverage;
a showroom comprising a customer-accessible physical space of a retail store containing (i) a first plurality of items available for customer self-service, and (ii) a first plurality of item identifiers accessible for scanning;
stock room comprising a secured physical space of the retail store containing a second plurality of items, wherein the second plurality of items comprises items associated with the first plurality of item identifiers; and
a pickup area comprising a customer-accessible physical space of the retail store having a visual identifier.

17. The physical store arrangement of claim 16, wherein the first plurality of item identifiers comprises item packaging associated with second plurality of items.

18. A computer system comprising:
one or more data processing apparatuses including one or more processors, memory, and storage devices storing instructions that, when executed, cause the one or more processors to perform operations comprising:
determining, by a retail store system, whether a location of a customer device is within a predetermined proximity of the retail store; and
in response to determining that the location of the customer device is within the predetermined proximity of the retail store:
receiving, by the retail store system, an item identifier from the customer device;
determining, by the retail store system, a stock room location of the item within the stock room of the retail store in response to receiving the item identifier, wherein the stock room is a secured physical space of the retail store;
sending, by the retail store system, a first notification to an employee device, the first notification indicative of the item, the stock room location, and a collection point location;
receiving, by the retail store system, a checkout request from the customer device;
determining, by the retail store system, a pickup location within the retail store in response to receiving the checkout request, wherein the pickup location is a customer-accessible physical space of the retail store having a visible identifier; and
sending, by the retail store system, a second notification to an employee device indicative of the collection point location and the pickup location.

19. The computer system of claim 18, the operations further comprising sending, by the retail store system, a third notification to the customer device indicative of the visible identifier of the pickup location.

20. The computer system of claim 18, the operations further comprising:
scanning, by a point of sale device, a physical item in the pickup location in the retail store;
receiving, by the point of sale device, the list of requested items of the virtual cart from the retail store system; and
processing, by the point of sale device, a payment transaction associated with the physical item and the list of requested items of the virtual cart.
